(19) United States
(12) Patent Application Publication
(10) Pub. No.: US 2003/0036413 A1
(43) Pub. Date: Feb. 20, 2003

(54) Hand-free type wireless microphone device

(76) Inventor: Chun Shu Ylo, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/797,585

(22) Filed: Mar. 5, 2001

(51) Int. Cl. H04B 1/38

(52) U.S. Cl. 455/569; 455/550

(57) ABSTRACT

The present invention provides a hand-free type wireless microphone device, which comprises a shell body, a microphone, and a control circuit. The shell body has a power switch, a power-in jack, a channel switch, and a microphone jack. The back of the shell body has an assembly of a clamping sheet and a connection sheet so that the present invention can clamp on pocket or waist or be hung on neck for use. It is not necessary to hold the present invention by hand. The microphone is disposed on the shell body. The control circuit is provided in the shell body and is connected to the microphone. The control circuit is used to modulate and amplify an audio source outputted from the microphone, and then emit it out in infrared or Radiation Frequency way.

### FIELD OF THE INVENTION

The present invention relates to a hand-free type wireless microphone device and, more particularly, to a microphone device, which has a small volume, can clamp on something or be hung for use, can emit signals in infrared (IR) or Radiation Frequency (RF) way, and can replace the use of an emitter by means of the special structure and the modified internal circuit thereof.

### BACKGROUND OF THE INVENTION

Prior art microphones can be divided into handheld microphones and headset type microphones. A handheld microphone must be held by hand, and cannot be connected to an external microphone. A headset type microphone must be connected to an external emitter, which cannot be carried conveniently and has no function of microphone. Moreover, both these two kinds of microphones have large volumes.

Therefore, the above microphones in the prior art have inconvenience and drawbacks in practical use.

### SUMMARY OF THE INVENTION

To resolve the above drawbacks in the prior art, the primary object of the present invention is to improve the structure of a microphone so that it can clamp on something or be hung for use. It is not necessary to hold the microphone by hand. Moreover, the microphone can emit signals in IR or Radiation Frequency (RF) way and has the function of emitter.

To achieve the above object, the present invention provides a hand-free type microphone device, which comprises a shell body, a microphone, and a control circuit. The shell body has a power switch, a power-in jack, a channel switch, and a microphone jack. A rechargeable battery can be attached in the shell body. A clamping sheet is also provided on the back of the shell body. The clamping sheet can be a metallic sheet or a plastic sheet, and can be inserted between two holes of a connection sheet. The connection sheet further has a plurality of holes to be tied with a strand. The microphone is disposed on the shell body, and is a condenser microphone. The control circuit is provided in the shell body, and is connected to the microphone.

The control circuit comprises a first processing unit, a second processing unit, and a power supply unit. The first processing unit is connected to the microphone, and is used to secondarily amplify an audio source inputted from the microphone and to reduce noise. The second processing unit is connected to the first processing unit, and is used to modulate and amplify a signal outputted by the first processing unit, and then emit out the amplified signal via an emitting element. The emitting element is an infrared light-emitting diode (IR LED) or an antenna. The power supply unit is respectively connected to the first processing unit and the second processing unit via the power switch. When the power switch is on, the power supply unit can provide electricity for the first processing unit and the second processing unit.

The various objects and advantages of the present invention will be more readily understood from the following detailed description when read in conjunction with the appended drawings, in which:

### BRIEF DESCRIPTION OF THE DRAWINGS

FIG. 1 is a front perspective view according to a clamping type embodiment of the present invention;

FIG. 2 is a rear perspective view according to a clamping type embodiment of the present invention;

FIG. 3 is a plan view according to a hanging type embodiment of the present invention;

FIG. 4 is a perspective view showing the situation that a headset type microphone is inserted in a microphone jack of a microphone device of the present invention;

FIG. 5 is a circuit block diagram operated in infrared emitting way of the present invention; and

FIG. 6 is a circuit block diagram operated in Radiation Frequency (RF) way of the present invention.

### DETAILED DESCRIPTION OF THE PREFERRED EMBODIMENTS

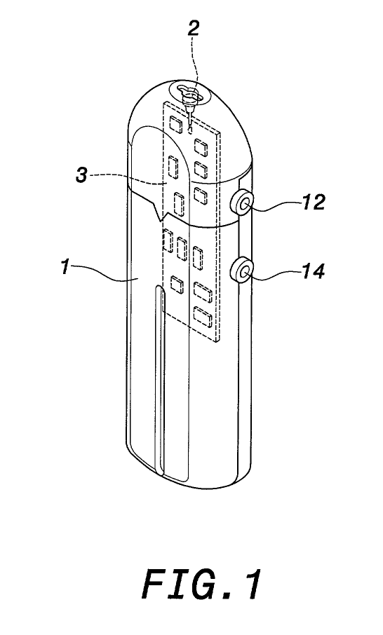

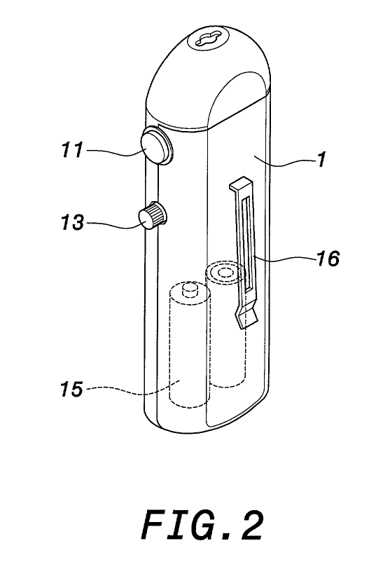

As shown in FIGS. 1 and 2, a hand-free type wireless microphone device of the present invention comprises a shell body 1, a microphone 2, and a control circuit 3.

The shell body has a power switch 11, a power-in jack 12, a channel switch 13, and a microphone jack 14 at two sides thereof. A rechargeable battery 15 is also attached in the shell body 1. The power-in jack 12 can be connected to an external power supply to charge the rechargeable battery 15. The channel switch 13 can change between the frequencies of 2.54 MHz and 2.08 MHz when operated in IR emitting way and can provide two kinds of frequencies for channel selection (adjusted according to local specification) when operated in The second processing unit 32 is respectively connected to the channel switch 13 and the first processing unit 31, and is formed by connecting a modulator 321, a amplifier 322, a driving amplifier 323, and an IR LED 324. The IR LED 24 is an emitting element. Signal outputted by the first processing unit 31 is modulated by the modulator 321. At this time, the user can change the channel using the channel switch 13. The modulated signal is amplified by the amplifier 322 and the driving amplifier 323, and is emitted out by the IR LED 324. Thereby, the present invention can emit out signal in IR way.

The power supply unit 33 is respectively connected to the rechargeable battery 15 and the power-in jack 12, and is respectively connected to the first processing unit 31 and the second processing unit 32 via the power switch 11. When the power switch 11 is on, the power supply unit 33 will provide electricity for the first processing unit 31 and the second processing unit 32.

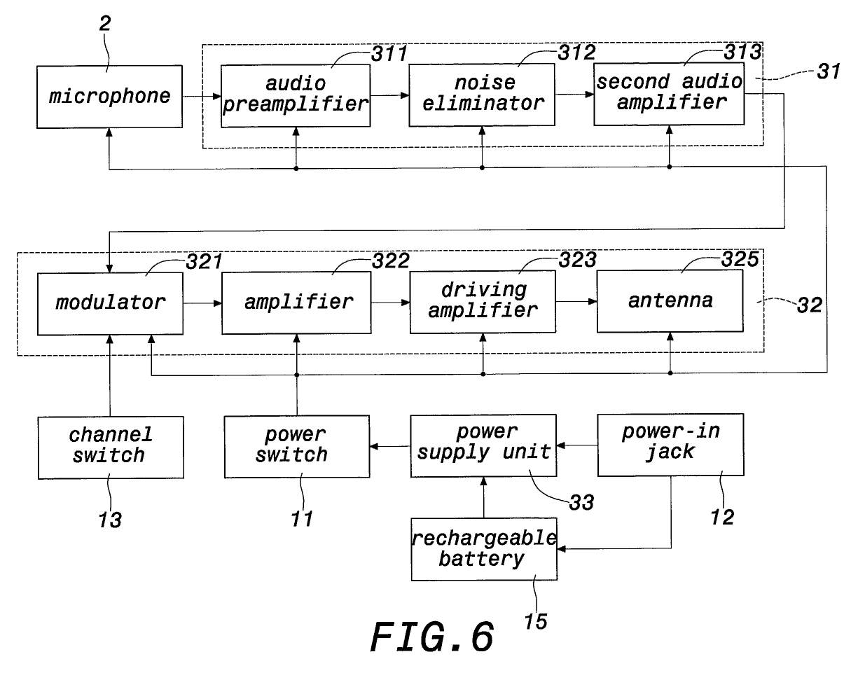

FIG. 6 shows a circuit block diagram of the present invention operated in wireless emitting way. The emitting element can be replaced with an antenna 325. The range of modulation of the modulator 321 can be around 200 MHz or 500 MHz, or even higher (adjusted according to local specification). Through the amplification of the amplifier 322 and the driving amplifier 323 and the emitting of the antenna 325, the present invention can emit signal in Radiation Frequency way.

To sum up, the hand-free type wireless microphone of the present invention has a small volume, can clamp on something or be hung for use, can be carried conveniently, can emit out signal in IR or Radiation Frequency way, and can be used as an transmitter. wireless emitting way. The microphone 2 is disposed on the shell body 1, and is a condenser microphone. The back of the shell body 1 joins a clamping sheet 16, which can be a metallic sheet or a plastic sheet. Thereby, the present invention can clamp on pocket or waist for use to achieve hand-free function.

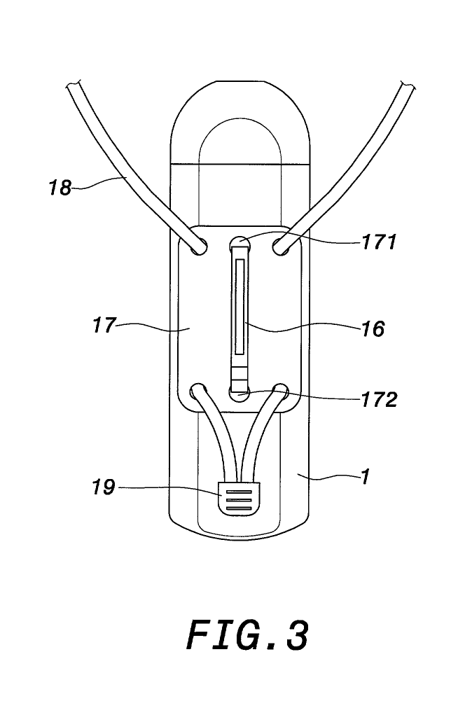

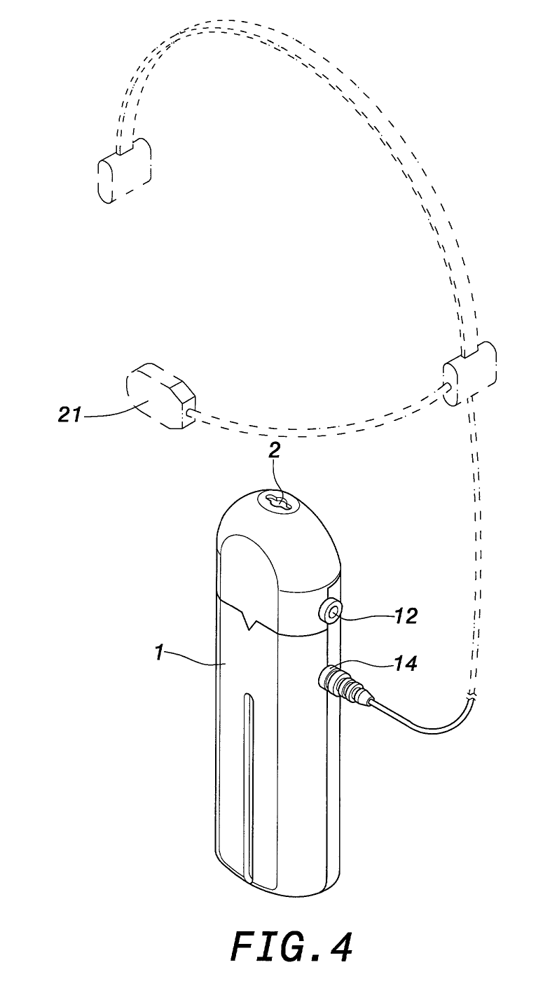

As shown in FIG. 3, the clamping sheet 16 can be inserted between two inner holes 171 of a connection sheet 17, which also has a plurality of holes 172 to be tied with a strand 18. One end of the strand 18 is telescoped in a bushing 19, the other end thereof can be hung on neck. Thereby, the present invention can be hung for use to achieve hand-free function. Additionally, a headset type microphone 21 (shown in FIG. 4) or another microphone can be inserted in the microphone jack 14 to meet requirements of special situations. For instance, microphones of different uses must be used for the situation of high fidelity or high background noise. The range of use of the present invention is increased, hence obtaining a multipurpose microphone device.

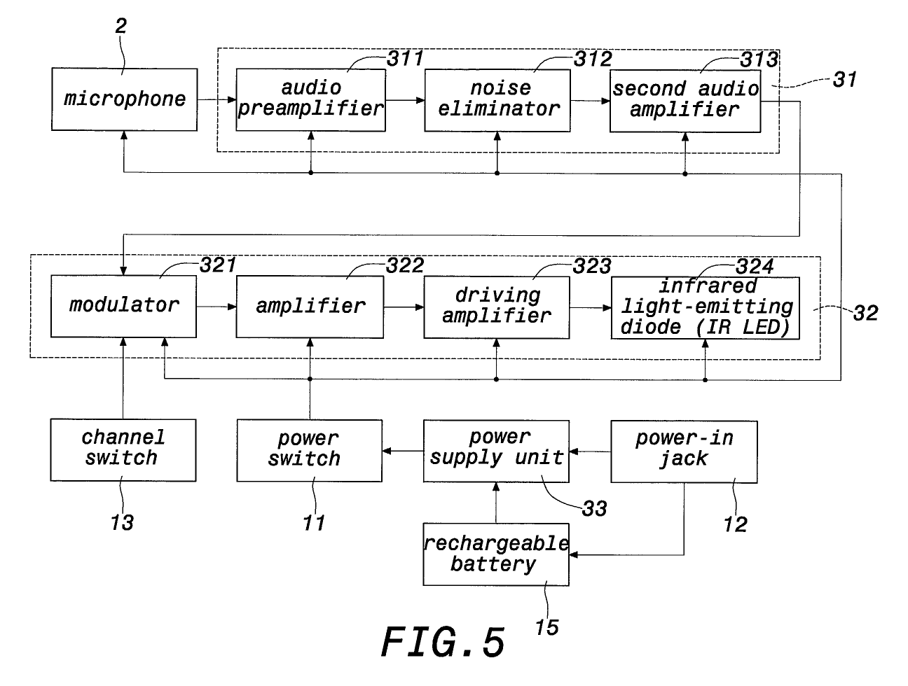

FIG. 5 shows a circuit block diagram of the present invention operated in IR emitting way. The control circuit 3 is disposed in the shell body 1 and is connected to the microphone 2. The control circuit 3 is used to modulate and amplify an audio source inputted from the microphone 2, and then emit it out in IR way. The control circuit 3 comprises a first processing unit 31, a second processing unit 32, and a power supply unit 33.

The first processing unit 31 is connected to the microphone 2, and is formed by connecting a first audio preamplifier 311, a noise eliminator 312, and a second audio amplifier 313. The first processing unit 31 is used to secondarily amplify an audio source inputted from the microphone 2.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A hand-free type wireless microphone device comprising:
a shell body having a power switch, a power-in jack, a channel switch, and a microphone jack, a back of said shell body having a clamping sheet to be inserted between two hole of a connection sheet, said connection sheet also having a plurality of holes to be tied with a strand;
a microphone disposed on said shell body; and
a control circuit disposed in said shell body and connected to said microphone, said control circuit being used to modulate and amplify an audio source inputted from said microphone, and then emit it out.

2. The hand-free type wireless microphone device as claimed in claim 1, wherein said shell body can have a rechargeable battery attached therein.

3. The hand-free type wireless microphone device as claimed in claim 1, wherein said microphone jack can be inserted by a headset type microphone.

4. The hand-free type wireless microphone device as claimed in claim 1, wherein said clamping sheet is a metallic sheet or a plastic sheet.

5. The hand-free type wireless microphone device as claimed in claim 1, wherein said microphone is a condenser microphone.

6. The hand-free type wireless microphone device as claimed in claim 1, wherein said control circuit comprises:
a first processing unit connected to said microphone and used to secondarily amplify said audio source inputted from said microphone and to reduce noise;
a second processing unit connected to said first processing unit and used to modulate signal outputted by said first processing unit, amplify it, and then emit it out via an emitting element; and
a power supply unit respectively connected to said first processing unit and said second processing unit via said power switch, said power supply unit providing electricity for said first processing and said second processing when said power switch is on.

7. The hand-free type wireless microphone device as claimed in claim 6, wherein said emitting element is an infrared light-emitting diode or an antenna.
